(19) United States
(12) Patent Application Publication
(10) Pub. No.: US 2006/0287150 A1
(43) Pub. Date: Dec. 21, 2006

(54) Powertrain of hybrid vehicle

(76) Inventors: Yeon Ho Kim, Suwon-city (KR); Wan Soo Kim, Hwaseong-city (KR); Kyung Ha Kim, Yongin-city (KR); Tal Chol Kim, Hwaseong-city (KR); Hee Ra Lee, Anyang-city (KR); Joo Woong Youn, Gunpo-city (KR); Kyung Won Hwang, Hwaseong-city (KR); Seong Jae Song, Hwaseong-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,723

(22) Filed: Dec. 15, 2005

(30) Foreign Application Priority Data
Jun. 17, 2005 (KR) 10-2005-0052473

(51) Int. Cl. F16H 3/72; F16H 37/08

(52) U.S. Cl. 475/5; 475/204

(57) ABSTRACT

A powertrain of a hybrid vehicle includes: a first shaft to which an engine, a generator, and a motor are mounted, and to which a planetary gear set is also mounted between the generator and the motor; a second shaft to which are mounted a second shaft driven gear connected to the first shaft and a second shaft drive gear shaft-connected to the second shaft driven gear; a third shaft to which are mounted a third shaft driven gear connected to the second shaft and a third shaft drive gear shaft-connected to the third shaft driven gear; and a fourth shaft to which are mounted a differential ring gear connected to the third shaft and a differential apparatus.

### CROSS-REFERENCE TO RELATED APPLICATION

This application claims priority to and the benefit of Korean Patent Application No. 10-2005-0052473 filed in the Korean Intellectual Property Office on Jun. 17, 2005, the entire contents of which are incorporated herein by reference.

### BACKGROUND OF THE INVENTION

(a) Field of the Invention

The present invention relates to a powertrain of a hybrid vehicle.

(b) Description of the Related Art

Generally, a driving system of a hybrid vehicle using an engine and a motor as power sources can be realized as various powertrains by delivering two types of power to a differential apparatus.

In a hybrid vehicle, power is delivered to a transmission via a motor while an engine operates, and a speed of the power delivered to the transmission is changed under an arbitrary gear ratio and is then transmitted to a differential apparatus.

However, such a conventional powertrain of a hybrid vehicle has a problem in that a space of an engine compartment is not sufficient so that there are many limitations in design of an engine, a transmission, and a motor.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a powertrain of a hybrid vehicle having advantages of having small total length and easily regulating power delivery of an engine and a motor.

An exemplary powertrain of a hybrid vehicle according to an embodiment of the present invention includes: a first shaft to which an engine, a generator, and a motor are mounted, and to which a planetary gear set is also mounted between the generator and the motor; a second shaft to which are mounted a second shaft driven gear connected to the first shaft so as to receive power from the planetary gear set of the first shaft and a second shaft drive gear shaft-connected to the second shaft driven gear so as to rotate together with the second shaft driven gear; a third shaft to which are mounted a third shaft driven gear connected to the second shaft so as to receive power from the second shaft drive gear and a third shaft drive gear shaft-connected to the third shaft driven gear so as to rotate together with the third shaft driven gear; and a fourth shaft to which are mounted a differential ring gear connected to the third shaft so as to receive power from the third shaft drive gear and a differential apparatus.

A sprocket drive gear for driving the second shaft driven gear may be integrally formed on an exterior circumference of a ring gear of the planetary gear set of the first shaft.

The sprocket drive gear of the first shaft and the second shaft driven gear may be connected to each other by a sprocket chain.

Both ends of the second shaft and the third shaft may be supported by a differential case.

The second shaft drive gear may be formed to be smaller than the second shaft driven gear and may be disposed to be closer to the engine than the second shaft driven gear.

The third shaft drive gear may be formed to be smaller than the third shaft driven gear and may be disposed to be closer to the engine than the third shaft driven gear.

The differential apparatus may be disposed to be closer to the engine than the differential ring gear.

The differential apparatus may be disposed to be farther from the engine than the differential ring gear.

An exterior circumference of the ring gear of the planetary gear set may be supported by a bearing.

### BRIEF DESCRIPTION OF THE DRAWINGS

FIG. 1 is a drawing showing a powertrain of a hybrid vehicle according to a first exemplary embodiment of the present invention.

FIG. 2 is a drawing showing a powertrain of a hybrid vehicle according to a second exemplary embodiment of the present invention.

Description of Reference Numerals Indicating Primary Elements in
the Drawings

| | |
|---|---|
| 110: generator | 112: motor |
| 114: ring gear | 116: sprocket chain |

### DETAILED DESCRIPTION OF THE EMBODIMENTS

Exemplary embodiments of the present invention will hereinafter be described in detail with reference to the accompanying drawings.

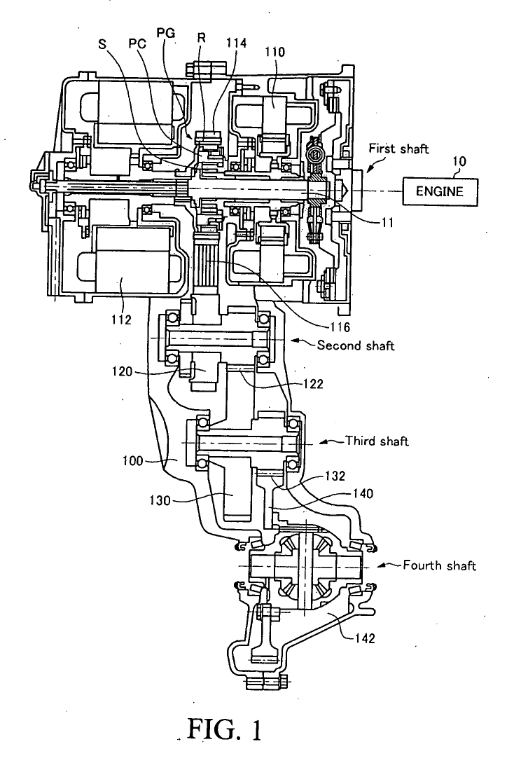

FIG. 1 is a cross-sectional view of a powertrain of a hybrid vehicle according to a first exemplary embodiment of the present invention.

Referring to FIG. 1, a powertrain of a hybrid vehicle according to the first exemplary embodiment of the present invention will be explained.

As shown in FIG. 1, a powertrain of a hybrid vehicle according to the first exemplary embodiment of the present invention includes an engine 10, a generator 110, a motor 112, and a differential apparatus 142. A planetary gear set PG is disposed between the motor 112 and the generator 110, and the powertrain includes first, second, third, and fourth shafts.

The engine 10, the generator 110, and the motor 112 are mounted to the first shaft, and the planetary gear set PG is disposed between the generator 110 and the motor 112.

For example, the planetary gear set PG may be realized as a simple planetary gear set including a sun gear S, a planet carrier PC, and a ring gear R as operational elements thereof. The sun gear S may be connected to the generator 110 via a power transmitting member, the planet carrier PC may be connected to an input shaft 11 receiving power from the engine via a power transmitting member, and the ring gear R may be connected to the motor 112 via a power transmitting member.

A second shaft driven gear 120 connected to the first shaft so as to receive power from the planetary gear set PG of the first shaft and a second shaft drive gear 122 shaft-connected to the second shaft driven gear 120 so as to rotate together with the second shaft driven gear 120 are mounted to the second shaft.

The second shaft drive gear 122 mounted on an axis line of the second shaft is formed to be smaller than the second shaft driven gear 120 and is disposed to be closer to the engine 10 than the second shaft driven gear 120.

In the exemplary embodiment of the present invention, a sprocket drive gear 114 is integrally formed on an exterior circumference of the ring gear R of the planetary gear set PG.

Under such a construction, the sprocket drive gear 114 of the first shaft and the second shaft driven gear 120 are connected to each other by a sprocket chain 116.

A third shaft driven gear 130 connected to the second shaft drive gear 122 so as to receive power from the second shaft drive gear 122 and a third shaft drive gear 132 shaft-connected to the third shaft driven gear 130 so as to rotate together with the third shaft driven gear 130 are mounted to the third shaft.

The third shaft drive gear 132 mounted on an axis line of the third shaft is formed to be smaller than the third shaft driven gear 130 and is disposed to be closer to the engine 10 than the third shaft driven gear 130.

Both the second shaft and the third shaft are disposed within a differential case 100, and both ends of the second and third shafts are supported by the differential case 100.

A differential ring gear 140 connected to the third shaft by being engaged with the third shaft drive gear 132 and a differential apparatus 142 are mounted to the fourth shaft.

The differential apparatus 142, disposed on an axis line of the fourth shaft, is positioned to be closer to the engine 10 than the differential ring gear 140.

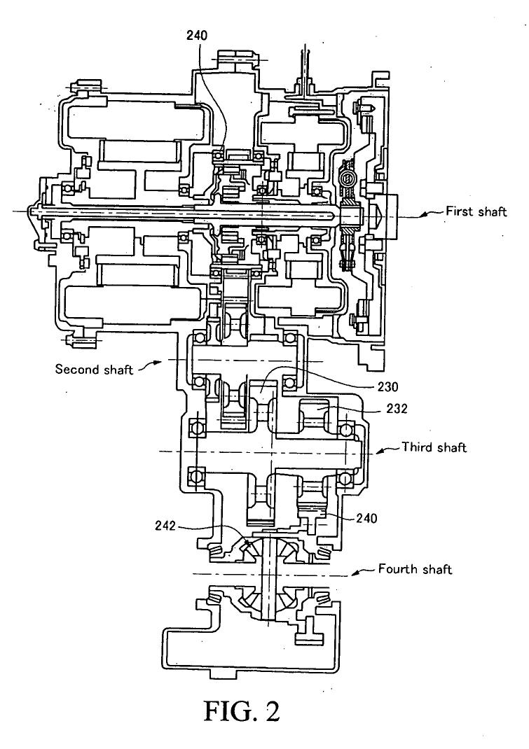

FIG. 2 is a cross-sectional view of a powertrain of a hybrid vehicle according to a second exemplary embodiment of the present invention.

Referring to FIG. 2, a powertrain of a hybrid vehicle according to the second exemplary embodiment of the present invention will be explained.

The basic construction of the powertrain according to the second exemplary embodiment of the present invention is equal to that of the powertrain according to the first exemplary embodiment of the present invention, and so explanation of the same will be omitted.

As shown in FIG. 2, in a powertrain of a hybrid vehicle according to the second exemplary embodiment, a third shaft drive gear 232 mounted to the third shaft is formed to be smaller than a third shaft driven gear 230 and is disposed to be closer to the engine than the third shaft driven gear 230.

In addition, a differential ring gear 240 connected to the third shaft by being engaged with the third shaft drive gear 232 and a differential apparatus 242 are mounted to the fourth shaft.

Different from the first exemplary embodiment, in the second exemplary embodiment, the differential apparatus 242, disposed on an axis line of the fourth shaft, is farther from the engine than the differential ring gear 240.

By such a construction, a total length of the powertrain of a hybrid vehicle according to the second exemplary embodiment of the present invention may become shorter than that of the powertrain according to the first exemplary embodiment of the present invention.

As stated above, exemplary embodiments of the present invention relate to a powertrain of a hybrid vehicle using an engine and a motor as power sources thereof, and the powertrain has four shafts as shown in FIG. 1 and FIG. 2.

In the exemplary embodiments of the present invention, power distribution of the motor, the generator, and the engine is controlled by the planetary gear set, and the sprocket gear is integrally formed on the exterior circumference of the ring gear R of the planetary gear set PG so as to deliver power to the second shaft.

That is, the planetary gear set is disposed between the motor and the generator, and the sprocket drive gear is integrally formed on the exterior circumference of the ring gear of the planetary gear set.

In addition, as shown in FIG. 2, an exterior circumference of the ring gear is supported by a bearing 240.

Due to such a construction, the powertrain of a hybrid vehicle according to the exemplary embodiments of the present invention has a substantially small total length.

In addition, power delivery from the second shaft to the third shaft and from the third shaft to the fourth shaft is performed by gears, and power delivery is performed in a direction toward the engine, so that equal stiffness of a drive shaft of a hybrid vehicle can be easily realized.

As stated above, in exemplary embodiments of the present invention, power distribution of the motor, the generator, and the engine is performed by the planetary gear set, and a driving torque needed for driving a vehicle is delivered to the second shaft through the sprocket chain connected to the ring gear of the planetary gear set.

The third shaft connected to the second shaft via a speed reduction gear reduces a speed of the power transmitted from the second shaft via a speed reduction gear and then transmits the power to the wheels (not shown) via the differential mounted to the fourth shaft.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As stated above, in a powertrain of a hybrid vehicle according to embodiments of the present invention, a sprocket drive gear is integrally formed on an exterior circumference of a ring gear of a planetary gear set so as to drive a chain, so that an overall length of the powertrain can be substantially decreased. Furthermore, power transmitting gears of the second and third shafts are positioned at a side closer to the engine, so that construction of a speed reduction gear ratio can be easily realized.

In addition, equal stiffness of a drive shaft of a hybrid vehicle can be easily realized, so that advantageous effects in noise and durability can be obtained.

What is claimed is:

1. A powertrain of a hybrid vehicle, comprising:
a first shaft to which an engine, a generator, and a motor are mounted, and to which a planetary gear set is also mounted between the generator and the motor;
a second shaft to which are mounted a second shaft driven gear connected to the first shaft so as to receive power from the planetary gear set of the first shaft and a second shaft drive gear shaft-connected to the second shaft driven gear so as to rotate together with the second shaft driven gear;
a third shaft to which are mounted a third shaft driven gear connected to the second shaft so as to receive power from the second shaft drive gear and a third shaft drive gear shaft-connected to the third shaft driven gear so as to rotate together with the third shaft driven gear; and
a fourth shaft to which are mounted a differential ring gear connected to the third shaft so as to receive power from the third shaft drive gear and a differential apparatus.

2. The powertrain of claim 1, wherein
a sprocket drive gear for driving the second shaft driven gear is integrally formed on an exterior circumference of a ring gear of the planetary gear set of the first shaft.

3. The powertrain of claim 2, wherein
the sprocket drive gear of the first shaft and the second shaft driven gear are connected to each other by a sprocket chain.

4. The powertrain of claim 3, wherein
both ends of the second shaft and the third shaft are supported by a differential case.

5. The powertrain of claim 2, wherein:
the second shaft drive gear is formed to be smaller than the second shaft driven gear and is disposed to be closer to the engine than the second shaft driven gear.

6. The powertrain of claim 2, wherein
the third shaft drive gear is formed to be smaller than the third shaft driven gear and is disposed to be closer to the engine than the third shaft driven gear.

7. The powertrain of claim 2, wherein
the differential apparatus is disposed to be closer to the engine than the differential ring gear.

8. The powertrain of claim 2, wherein
the differential apparatus is disposed to be farther from the engine than the differential ring gear.

9. The powertrain of claim 2, wherein
an exterior circumference of a ring gear of the planetary gear set is supported by a bearing.
